(19) United States
(12) Patent Application Publication
(10) Pub. No.: US 2013/0219208 A1
(43) Pub. Date: Aug. 22, 2013

(54) METHOD OF CORRECTING A DUTY RATIO OF A DATA STROBE SIGNAL

(71) Applicant: Samsung Electronics Co., Ltd., (US)

(72) Inventors: Kyoung-Mook LIM, Hwaseong-si (KR); Jin-Su JUNG, Suwon-si (KR); Kwan-Ho KIM, Suwon-si (KR); Jung-Rae KIM, Seoul (KR); Tae-Sun KIM, Seongnam-si (KR)

(73) Assignee: SAMSUNG ELECTRONICS CO., LTD., Suwon-Si (KR)

(21) Appl. No.: 13/747,656

(22) Filed: Jan. 23, 2013

(30) Foreign Application Priority Data
Jan. 25, 2012 (KR) 10-2012-0007172

(51) Int. Cl. G06F 1/04

(52) U.S. Cl. CPC G06F 1/04
USPC 713/503

(57) ABSTRACT

A method of correcting a duty ratio of a data strobe signal is provided. By the method, a duty ratio of a data strobe signal output from a semiconductor memory device is detected and a duty ratio of a clock signal input to the semiconductor memory device is adjusted based on the duty ratio of the data strobe signal.

### CROSS-REFERENCE TO RELATED APPLICATION(S)

This application claims priority under 35 USC §119 to Korean Patent Applications No. 10-2012-0007172, filed on Jan. 25, 2012 in the Korean Intellectual Property Office (KIPO), the contents of which are incorporated herein in their entirety by reference.

### BACKGROUND

1. Technical Field

Example embodiments relate to correcting a duty ratio of a data strobe signal for a semiconductor memory device.

2. Description of the Related Art

As an electronic device (e.g., a mobile device) operates at a high speed, data is transmitted at a high speed between a system on-chip (SOC) and a semiconductor memory device (e.g., a DDR SDRAM device) in the electronic device. A duty cycle of a signal is the time that the spends in an active state as a fraction of the total time under consideration. During high speed operation, a duty error (e.g., an incorrect duty cycle) may arise during transmission of a clock signal to the semiconductor memory device and/or internally in the semiconductor memory device during operation. In this case, a signal distortion phenomenon due to the duty error of a data strobe signal (DQS) may occur while the data is transmitted between the system on-chip and the semiconductor memory device. Generally, the data strobe signal is generated based on a clock signal that is applied into the semiconductor memory device. Here, a duty error may be caused when the clock signal is transmitted to the semiconductor memory device. In addition, a duty error may be also caused inside the semiconductor memory device. As a result, a duty ratio of the data strobe signal (i.e., a ratio of a logic high level period of the data strobe signal to an entire period of the data strobe signal) may not be maintained to be a desired value (e.g., 50%) even when a duty ratio of the clock signal (i.e., a ratio of a logic high level period of the clock signal to an entire period of the clock signal) is maintained to be an ideal percentage (e.g., 50%).

### SUMMARY

Some example embodiments provide a method of correcting a duty ratio of a data strobe signal capable of maintaining a duty ratio of a data strobe signal to be a desired value (e.g., an ideal percentage, 50%).

According to some example embodiments, a method of correcting a duty ratio of a data strobe signal may include detecting a duty ratio of a data strobe signal output from a semiconductor memory device, and adjusting a duty ratio of a clock signal input to the semiconductor memory device based on the duty ratio of the data strobe signal.

In example embodiments, the semiconductor memory device may be a double data rate synchronous dynamic random access memory (DDR SDRAM) device.

In example embodiments, the adjusting is repeatedly performed until the duty ratio of the data strobe signal is a desired ratio.

In example embodiments, the desired ratio may be 50%.

In example embodiments, the repeatedly performing the adjusting ends if the duty ratio of the data strobe signal becomes equal to the desired ratio.

In example embodiments, the data strobe signal may include a first period and a second period, the first period corresponding to a period where the data strobe signal has a logic high level and the second period corresponding to a period where the data strobe signal has a logic low level. The duty ratio of the data strobe signal may correspond to a ratio of the first period to a sum of the first period and the second period.

In example embodiments, the clock signal may include a third period and a fourth period. The third period may correspond to a period where the clock signal has a logic high level and the fourth period may correspond to a period where the clock signal has a logic low level period. The duty ratio of the clock signal may correspond to a ratio of the third period to a sum of the third period and the fourth period.

In example embodiments, the adjusting may include increasing the duty ratio of the clock signal if the duty ratio of the data strobe signal is less than the desired ratio, and reducing the duty ratio of the clock signal if the duty ratio of the data strobe signal is greater than the desired ratio.

In example embodiments, the increasing the duty ratio of the clock signal may include at least one of lengthening the third period and shortening the fourth period if the duty ratio of the data strobe signal is less than the desired ratio.

In example embodiments, the reducing the duty ratio of the clock signal may include at least one of shortening the third period and lengthening the fourth period if the duty ratio of the data strobe signal is greater than the desired ratio.

In example embodiments, the detecting and adjusting may be performed only when a duty ratio correction command signal is received.

In example embodiments, the detecting and adjusting may be performed based on a desired cycle.

In example embodiments, the detecting and adjusting may be performed if a temperature of the semiconductor memory device is within a desired temperature range.

In example embodiments, the detecting and adjusting may be performed if an operating voltage of the semiconductor memory device is within a desired voltage range.

In example embodiments, the detecting and adjusting may be performed if an operating speed of the semiconductor memory device is within a desired speed range.

Example embodiments include a method of controlling a duty ratio of an output signal output from a semiconductor memory device. The duty ratio of the output signal depending on a duty ratio of a clock signal input to the semiconductor memory device. The method includes adjusting a duty ratio of the clock signal input to the semiconductor memory device, if the duty ratio of the output signal from the semiconductor memory device deviates from a desired ratio.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of correcting a duty ratio of a data strobe signal according to example embodiments.

FIG. 2 is a block diagram illustrating an electronic device employing a method of FIG. 1.

FIG. 3 is a flow chart illustrating an example embodiment of a method of repeatedly performing the duty ratio correcting operation of FIG. 1.

FIG. 4 is a flow chart illustrating an example embodiment in which the method of FIG. 1 is performed based on a duty ratio correction command signal.

FIG. 5 is a flow chart illustrating an example embodiment in which the method of FIG. 1 is performed based on a desired (or, alternatively a predetermined) cycle.

FIG. 6 is a flow chart illustrating an example embodiment in which the method of FIG. 1 is performed based on a temperature of a semiconductor memory device.

FIG. 7 is a flow chart illustrating an example embodiment in which the method of FIG. 1 is performed based on an operating voltage of a semiconductor memory device.

FIG. 8 is a flow chart illustrating an example embodiment in which the method of FIG. 1 is performed based on an operating speed of a semiconductor memory device.

FIG. 9 is a block diagram illustrating an example embodiment of a device configured to correct a duty ratio of a data strobe signal according to example embodiments.

FIG. 10 is a block diagram illustrating an example embodiment in which the device of FIG. 9 includes a user interface for receiving a duty ratio correction command signal.

FIG. 11 is a block diagram illustrating an example embodiment in which the device of FIG. 9 includes a timer unit for providing a desired (or, alternatively predetermined) cycle.

FIG. 12 is a block diagram illustrating an example embodiment in which the device of FIG. 9 includes a temperature sensing unit for sensing a temperature of a semiconductor memory device.

FIG. 13 is a block diagram illustrating an example embodiment in which the device of FIG. 9 includes a voltage measuring unit for measuring an operating voltage of a semiconductor memory device.

FIG. 14 is a block diagram illustrating an example embodiment in which a device of FIG. 9 includes a speed measuring unit for measuring an operating speed of a semiconductor memory device.

FIG. 15 is a block diagram illustrating an example embodiment of mobile system that includes a device for correcting a duty ratio of a data strobe signal.

FIG. 16 is a block diagram illustrating an example embodiment of computing system that includes a device for correcting a duty ratio of a data strobe signal.

### DETAILED DESCRIPTION OF THE EMBODIMENTS

Various example embodiments will be described more fully hereinafter with reference to the accompanying drawings, in which some example embodiments are shown. The present inventive concepts may, however, be embodied in many different forms and should not be construed as limited to the example embodiments set forth herein. Rather, these example embodiments are provided so that this disclosure will be thorough and complete, and will fully convey the scope of the present inventive concepts to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

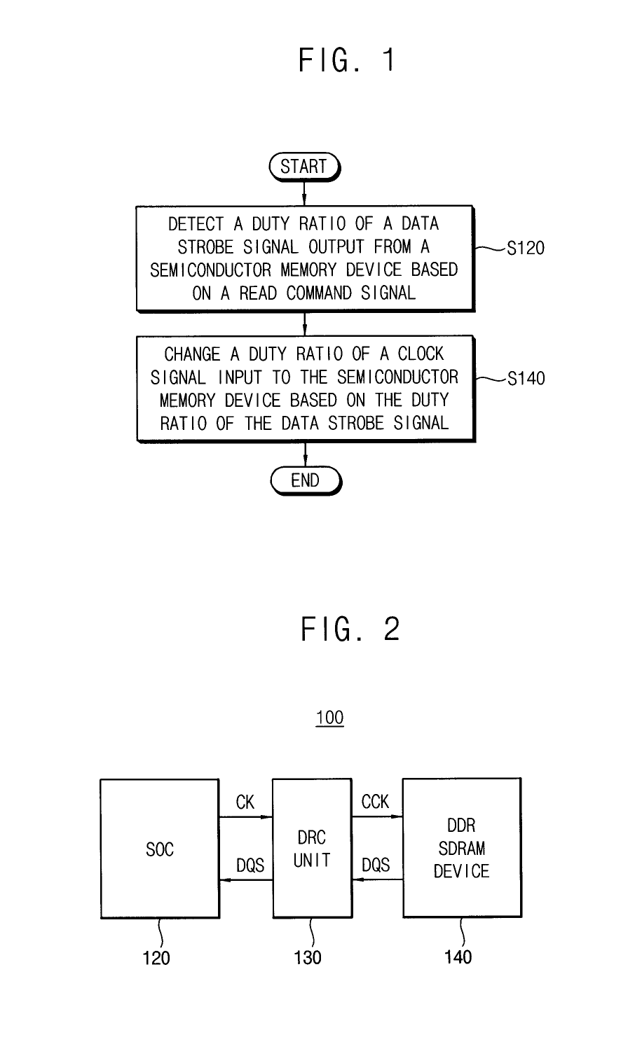

FIG. 1 is a flow chart illustrating a method of correcting a duty ratio of a data strobe signal according to example embodiments. FIG. 2 is a block diagram illustrating an electronic device employing the method of FIG. 1.

Referring to FIGS. 1 and 2, the electronic device 100 may include a system on-chip 120 integrated circuit (IC), a duty ratio correcting (DRC) unit 130, and a semiconductor memory device 140. The system on-chip 120 may be coupled to the semiconductor memory device 140 on a printed circuit board (PCB). In step S120, the DRC unit (130) may detect a duty ratio of a data strobe signal DQS output from the semiconductor memory device 140 based on a read command signal, and then may adjust a duty ratio of a clock signal CK input to the semiconductor memory device 140 based on the detected duty ratio of the data strobe signal DQS (Step S140). Although it is illustrated in FIG. 2 that the semiconductor memory device 140 is a DDR SDRAM device, the semiconductor memory device 140 is not limited thereto and may be embodied as any type of semiconductor memory device.

The electronic device 100 may operate at a high speed when executing various operations. During some operations, the semiconductor memory device 140 may store data, and the system on-chip 120 may include a plurality of modules for performing specific operations based on the data. To perform these high speed operations, data needs to be transmitted fast between the semiconductor memory device 140 and the system on-chip 120. However, when the data is transmitted fast between the semiconductor memory device 140 and the system on-chip 120, a signal distortion phenomenon may occur that results in a malfunction of the electronic device 100.

Generally, the clock signal CK may be generated inside the system on-chip 120, and then may be applied to the semiconductor memory device 140. For example, the duty ratio of the clock signal CK (e.g., a ratio of a logic high level period of the clock signal CK to an entire period of the clock signal CK) may be 50%. However, it is difficult to maintain the duty ratio of the clock signal CK. A duty error may be caused when the clock signal CK is transmitted from the system on-chip 120 to the semiconductor memory device 140. Hence, the duty ratio of the data strobe signal DQS may not be maintained to be a desired value (e.g., 50%) even when the duty ratio of the clock signal CK is maintained.

In addition, since the data strobe signal DQS generated in the semiconductor memory device 140 is generated based on the clock signal CK, the data strobe signal DQS may include a duty error that is caused in the semiconductor memory device 140 as well as a duty error of the clock signal CK. Further, a duty error may be added while the data strobe signal DQS is transmitted from the semiconductor memory device 140 to the system on-chip 120.

Generally, a duty error of the data strobe signal DQS reduces an effective time of data that is input to the system on-chip 120. For example, a DDR SRAM device may transmit data twice (i.e., once in the logic high level period of the clock signal CK and once in the logic low level period of the clock signal CK) during one cycle of the clock signal CK. Thus, an effective time of data may be determined based on the logic high level period of the data strobe signal DQS and the logic low level period of the data strobe signal DQS. In detail, a shorter period of the logic high level period of the data strobe signal DQS and the logic low level period of the data strobe signal DQS may be determined as an effective time of data. Therefore, an effective time of data may be maximized if the duty error of the data strobe signal DQS is minimized.

The electronic device 100 of FIG. 2 may correct the duty ratio of the data strobe signal DQS (i.e., may reduce or eliminate a duty error of the data strobe signal DQS) using the method of FIG. 1 to intentionally change (i.e., distort) the duty ratio of the clock signal CK that is output from the system on-chip 120 to the semiconductor memory device 140 based on the duty ratio of the data strobe signal DQS that is output from the semiconductor memory device 140 to the system on-chip 120. In detail, in Step S120, the DRC unit (130) may detect the duty ratio of the data strobe signal DQS that is output from the semiconductor memory device 140 to the system on-chip 120 based on the read command signal. The data strobe signal DQS may include a first period corresponding to the logic high level period of the data strobe signal DQS and a second period corresponding to the logic low level period of the data strobe signal DQS. The duty ratio of the data strobe signal DQS may be defined as a ratio of the first period to an entire period (i.e., a sum of the first period and the second period). However, the duty ratio of the data strobe signal DQS may be variously defined according to required conditions for the electronic device 100.

Subsequently, the in Step S140, the DRC unit 130 may adjust the duty ratio of the clock signal CK that is output from the system on-chip 120 to the semiconductor memory device 140 based on the duty ratio of the data strobe signal DQS. The clock signal CK may include a third period corresponding to the logic high level period of the clock signal CK and a fourth period corresponding to the logic low level period of the clock signal CK. The duty ratio of the clock signal CK may be defined as a ratio of the third period to an entire period (i.e., a sum of the third period and the fourth period). However, the duty ratio of the clock signal CK may be variously defined according to required conditions for the electronic device 100. Since the data strobe signal DQS is generated based on the clock signal CK, the duty ratio of the data strobe signal DQS depends on the duty ratio of the clock signal CK. In other words, as the duty ratio of the clock signal CK increases, the duty ratio of the data strobe signal DQS increases. Similarly, as the ratio of the clock signal CK decreases, the duty ratio of the data strobe signal DQS decreases.

Therefore, the DRC unit 130 may adjust the duty ratio of the clock signal CK by increasing the duty ratio of the clock signal CK when the duty ratio of the data strobe signal DQS is smaller than a desired (or alternatively, a predetermined) ratio (e.g., 50%), and by reducing the duty ratio of the clock signal CK when the duty ratio of the data strobe signal DQS is greater than the desired or predetermined ratio. The duty ratio of the clock signal CK may be increased by lengthening the third period corresponding to the logic high level period of the clock signal CK and/or by shortening the fourth period corresponding to the logic low level period of the clock signal CK, if the duty ratio of the data strobe signal DQS is less then the desired (or alternatively the predetermined) ratio. On the other hand, the DRC unit 130 may reduce the duty ratio of the clock signal CK by shortening the third period corresponding to the logic high level period of the clock signal CK and/or by lengthening the fourth period corresponding to the logic low level period of the clock signal CK, if the duty ratio of the data strobe signal DQS is greater than the desired (or alternatively the predetermined) ratio.

For example, if the logic high level period of the data strobe signal DQS is longer than the logic low level period of the data strobe signal DQS the logic high level period of the data strobe signal DQS needs to be shortened and/or the logic low level period of the data strobe signal DQS needs to be lengthened in order to control the duty ratio of the data strobe signal DQS to be the desired or predetermined ratio. That is, the DRC unit 130 may reduce the duty ratio of the data strobe signal DQS by reducing the duty ratio of the clock signal CK, as the duty ratio of the data strobe signal DQS depends on the duty ratio of the clock signal CK. Similarly, if the logic high level period of the data strobe signal DQS is shorter than the logic low level period of the data strobe signal DQS then the logic high level period of the data strobe signal DQS needs to be lengthened and/or the logic low level period of the data strobe signal DQS needs to be shortened in order to control the duty ratio of the data strobe signal DQS to be the desired or predetermined ratio. That is, the DRC unit 130 may increase the duty ratio of the data strobe signal DQS, as the duty ratio of the data strobe signal DQS depends on the duty ratio of the clock signal CK.

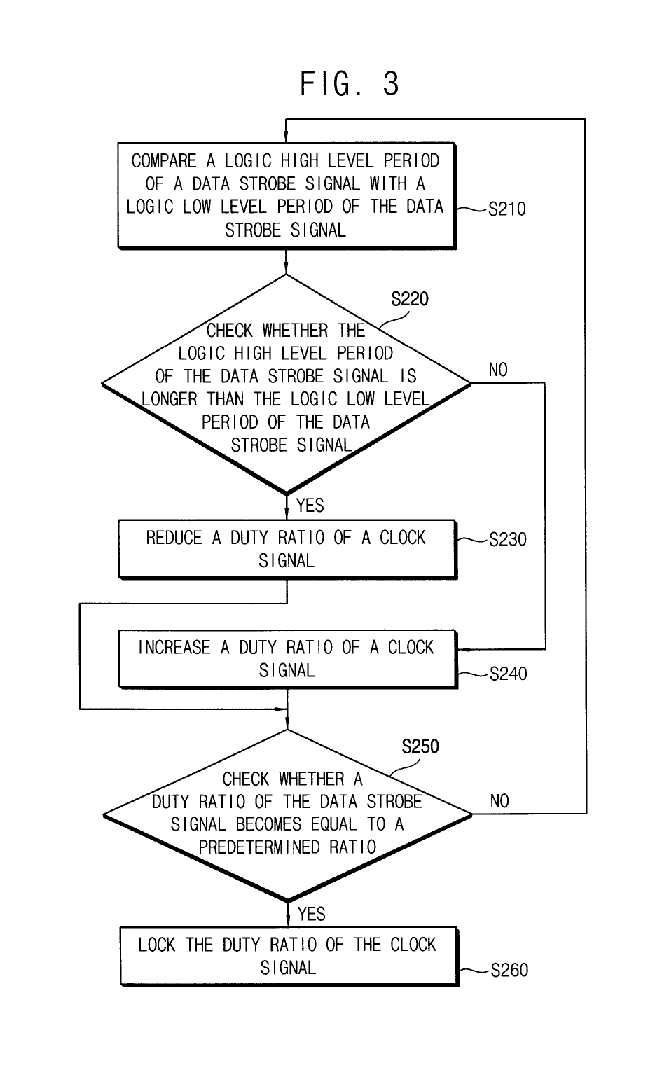

The duty ratio of the data strobe signal DQS may be satisfactorily controlled to be the desired (or alternatively, the predetermined) ratio when a duty ratio correcting operation for the data strobe signal DQS is performed only once by the DRC unit in the method of FIG. 1. In order to get better accuracy, however, the duty ratio correcting operation for the data strobe signal DQS may be repeatedly performed by the DRC unit 130 until the duty ratio of the data strobe signal DQS becomes equal to the desired (or alternatively, the predetermined) ratio. For example, if the desired (or alternatively, the predetermined) ratio is 50%, the duty ratio correcting operation for the data strobe signal DQS may be repeatedly performed by the DRC unit 130 until the duty ratio of the data strobe signal DQS that is output from the semiconductor memory device 140 to the system on-chip 120 becomes equal to 50%. When the duty ratio of data strobe signal DQS that is output from the semiconductor memory device 140 to the system on-chip 120 becomes equal to the desired (or alternatively, the predetermined) ratio (e.g., 50%), the DRC unit 130 may lock the duty ratio of the clock signal CK that is output from the system on-chip 120 to the semiconductor memory device 140. This operation will be described in detail with reference to FIG. 3.

The electronic device 100 may continuously or selectively perform the method of FIG. 1. If the electronic device 100 continuously performs the method of FIG. 1, the duty ratio of the data strobe signal DQS may be continuously maintained to be the desired (or alternatively, the predetermined) ratio. Thus, the electronic device 100 may achieve high operation reliability. However, since performing the method of FIG. 1 adds an additional load to the electronic device 100, a performance of the electronic device 100 may be degraded because the method of FIG. 1 is continuously performed. On the other hand, if the electronic device 100 selectively performs the method of FIG. 1, a performance of the electronic device 100 may be improved. However, the electronic device 100 may not achieve high operation reliability because the duty ratio of the data strobe signal DQS is not continuously maintained to be the desired (or alternatively, the predetermined) ratio. Therefore, the method of FIG. 1 needs to be continuously or selectively performed according to required conditions for the electronic device 100 by considering the above trade-off relation.

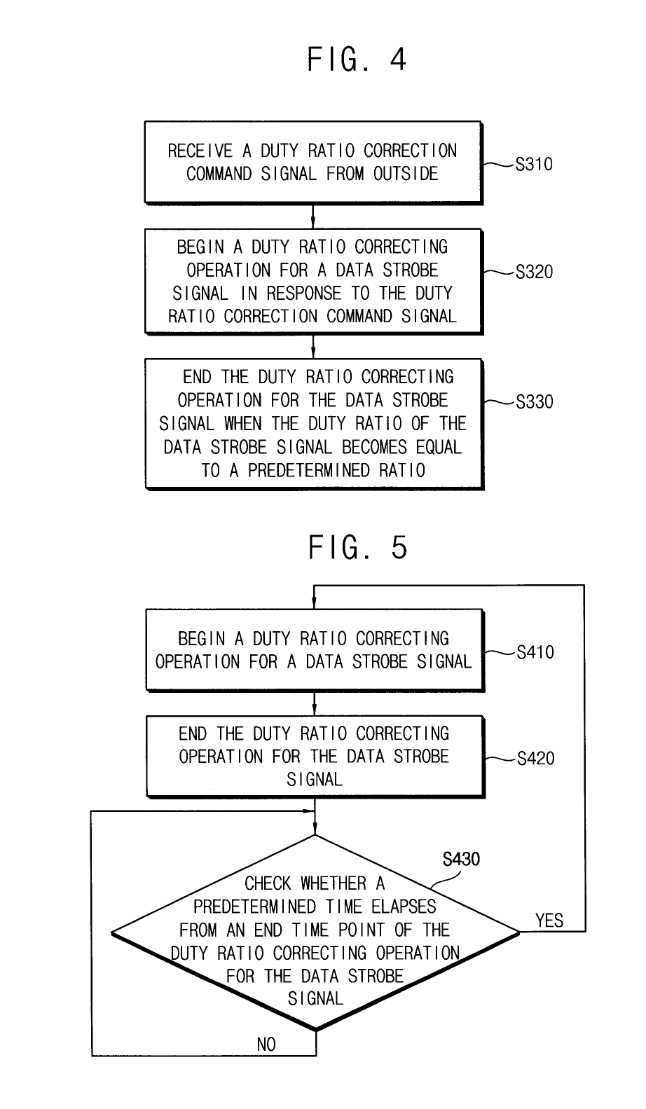

Hereinafter, in the example embodiments described below the electronic device 100 selectively performs the method of FIG. 1. However, the method discussed below may be continuously performed. In one example embodiment, the electronic device 100 may perform the method of FIG. 1 only when a duty ratio correction command signal is input from outside. That is, if the duty ratio correction command signal is input by a user, an operator or by an external device, the method of FIG. 1 may be performed in response to the duty ratio correction command signal. In another example embodiment, the electronic device 100 may perform the method of FIG. 1 based on a desired (or alternatively, a predetermined cycle) (i.e. every desired or predetermined cycle). In still another example embodiment, the electronic device 100 may perform the method of FIG. 1 only when a temperature of the semiconductor memory device 140 is within a desired (or alternatively, a predetermined) temperature range. In still another example embodiment, the electronic device 100 may perform the method of FIG. 1 only when an operating voltage of the semiconductor memory device 140 is within a predetermined voltage range. In still another example embodiment, the electronic device 100 may perform the method of FIG. 1 only when an operating speed of the semiconductor memory device 140 is within a desired (or alternatively, a predetermined) speed range. The above example embodiments will be described in detail with reference to FIGS. 4 through 8.

As described above, the electronic device 100 may perform the method of FIG. 1 to maintain the duty ratio of the data strobe signal DQS to a desired value (e.g., 50%) by the DRC unit 130 intentionally changing the duty ratio of the clock signal CK that is output from the system on-chip 120 to the semiconductor memory device 140 based on the duty ratio of the data strobe signal DQS that is output from the semiconductor memory device 140 (e.g., a DDR SDRAM device) to the system on-chip 120. Thus, compared to conventional duty ratio correction techniques that focus on maintaining the duty ratio of the clock signal CK to be a desired value, the electronic device 100 performing the method of FIG. 1 may greatly reduce a duty error of the data strobe signal DQS that is output from the semiconductor memory device 140 to the system on-chip 120. As a result, an effective time of data may be greatly increased for the electronic device 100. In addition, the electronic device 100 may be continuously or selectively perform the method of FIG. 1 according to required conditions for the electronic device 100.

FIG. 3 is a flow chart illustrating an example in which a duty ratio correcting operation of FIG. 1 is repeatedly performed by the electronic device 100. In FIG. 3, it will be assumed that the desired (or alternatively, the predetermined) ratio is 50%.

Referring to FIG. 3, in step S210 the electronic device 100 compares the logic high level period of the data strobe signal DQS with the logic low level period of the data strobe signal DQS, the data strobe signal DQS being output from the semiconductor memory device 140 to the system on-chip 120. In Step S220, the electronic device 100 checks whether the logic high level period of the data strobe signal DQS is longer than the logic low level period of the data strobe signal DQS. In Step S230, if the logic high level period of the data strobe signal DQS is longer than the logic low level period of the data strobe signal DQS, the DRC unit 130 reduces the duty ratio of the clock signal CK, the clock signal CK being output from the system on-chip 120 to the semiconductor memory device 140. On the other hand, in Step S240, if the logic high level period of the data strobe signal DQS is shorter than the logic low level period of the data strobe signal DQS, the DRC unit 130 increases the duty ratio of the clock signal CK, the clock signal CK being output from the system on-chip 120 to the semiconductor memory device 140. As described above, in the method of FIG. 3 the electronic device 100 may reduce the duty ratio of the clock signal CK by shortening the logic high level period of the clock signal CK and/or by lengthening the logic low level period of the clock signal CK. On the other hand, in the method of FIG. 3 the electronic device 100 may increase the duty ratio of the clock signal CK by lengthening the logic high level period of the clock signal CK and/or by shortening the logic low level period of the clock signal CK.

Subsequently, in Step S250, the electronic device 100 may check whether the duty ratio of the data strobe signal DQS is equal to the desired or predetermined ratio (e.g., 50%). If the duty ratio of the data strobe signal DQS becomes equal to the desired or predetermined ratio, then in Step S260 the electronic device may lock the duty ratio of the clock signal CK. On the other hand, if the duty ratio of the data strobe signal DQS does not become equal to the desired or predetermined ratio, the electronic device 100 may perform the Steps S210, S220, S230, S240, and S250 again. Thus, the electronic device 100 may continuously correct the duty ratio of the clock signal CK using the method of FIG. 3 until the duty ratio of the data strobe signal DQS becomes equal to the desired or predetermined ratio. As a result, an electronic device 100 employing the method of FIG. 3 may achieve high operation reliability because an effective time of data is increased by reducing a duty error of the data strobe signal DQS.

FIG. 4 is a flow chart illustrating an example in which the electronic device 100 performs the method of FIG. 1 based on a duty ratio correction command signal.

Referring to FIG. 4, in Step S310 the electronic device 100 may receive the duty ratio correction command signal from outside. Then in Step S320, a duty ratio correcting operation may begin for the data strobe signal DQS that is output from the semiconductor memory device 140 to the system on-chip 120 in response to the duty ratio correction command signal. That is, the method of FIG. 4 may not be continuously performed, but the method of FIG. 4 may be selectively performed if the duty ratio correction command signal is input from outside (e.g., by a user or an external device). The DRC unit 130 may adjust the duty ratio of the data strobe signal DQS by intentionally changing the duty ratio of the clock signal CK that is output from the system on-chip 120 to the semiconductor memory device 140. Subsequently, in Step S330 the DRC unit 130 may end the duty ratio correcting operation for the data strobe signal DQS when the duty ratio of the data strobe signal DQS becomes equal to the desired or predetermined ratio (e.g., 50%). Since the electronic device 100 selectively performs the method of FIG. 4 in response to the duty ratio correction command signal, the electronic device 100 may operate relatively fast.

FIG. 5 is a flow chart illustrating an example embodiment in which the electronic device 100 performs the method of FIG. 1 cyclically based on a desired (or alternatively a predetermined) cycle.

Referring to FIG. 5, the electronic device 100 may perform the duty ratio correcting operation once in a manner discussed with regard to FIG. 4 (e.g., the duty correction operation may begin for the data strobe signal DQS that is output from the semiconductor memory device 140 to the system on-chip 120 (Step S410). The DRC unit 130 may perform the duty ratio correcting operation for the data strobe signal DQS to adjust the duty ratio of the data strobe signal DQS by intentionally changing the duty ratio of the clock signal CK that is output from the system on-chip 120 to the semiconductor memory device 140. Thereafter, the correction operation may end (Step S420). Subsequently, the electronic device 100 may check whether the desired (or alternatively, the predetermined) time elapses from an end time point of the duty ratio correcting operation for the data strobe signal DQS (Step S430). The electronic device 100 may begin again the duty ratio correcting operation for the data strobe signal DQS when the desired (or alternatively, the predetermined) time elapses from the end time point of the duty ratio correcting operation for the data strobe signal DQS. However, the electronic device 100 may not perform the duty ratio correcting operation for the data strobe signal DQS, if the desired (or alternatively the predetermined) time has not elapsed from the end time point of the duty ratio correcting operation for the data strobe signal DQS. Since the electronic device 100 performs the method of FIG. 5 based on the desired (or alternatively, the predetermined) cycle (i.e., every desired or predetermined cycle), the electronic device 100 may operate relatively fast.

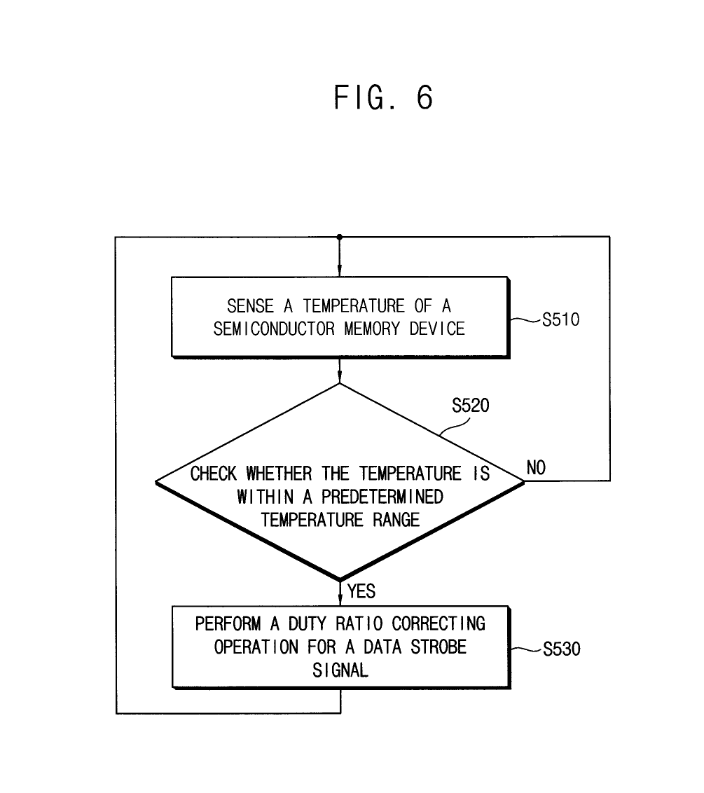

FIG. 6 is a flow chart illustrating an example embodiment in which the electronic device 100 performs the method of FIG. 1 based on a temperature of a semiconductor memory device.

Referring to FIG. 6, the electronic device 100 may detect the temperature of the semiconductor memory device 140 (Step S510), and then check whether the temperature of the semiconductor memory device 140 is within a desired (or alternatively, a predetermined) temperature range (Step S520). If the temperature of the semiconductor memory device 140 is within the predetermined temperature range, the electronic device 100 may perform the duty ratio correcting operation for the data strobe signal DQS. (Step S530). The DRC unit 130 may perform the duty ratio correcting operation for the data strobe signal DQS to adjust the duty ratio of the data strobe signal DQS by intentionally changing the duty ratio of the clock signal CK that is output from the system on-chip 120 to the semiconductor memory device 140. On the other hand, if the temperature of the semiconductor memory device 140 is not within the predetermined temperature range, the electronic device 100 may not be perform the duty ratio correcting operation for the data strobe signal DQS. Generally, a timing of the data strobe signal DQS may be influenced by a temperature change of the semiconductor memory device 140 while the electronic device 100 operates. Thus, the electronic device 100 may analyze an operation characteristics related to the temperature of the semiconductor memory device 140 using the method of FIG. 6, and may perform the duty ratio correcting operation for the data strobe signal DQS, if the temperature of the semiconductor memory device 140 is within the desired (or alternatively, the predetermined) temperature range (i.e., a range in which a timing of the data strobe signal DQS is greatly changed). As a result, the electronic device 100 may operate relatively fast.

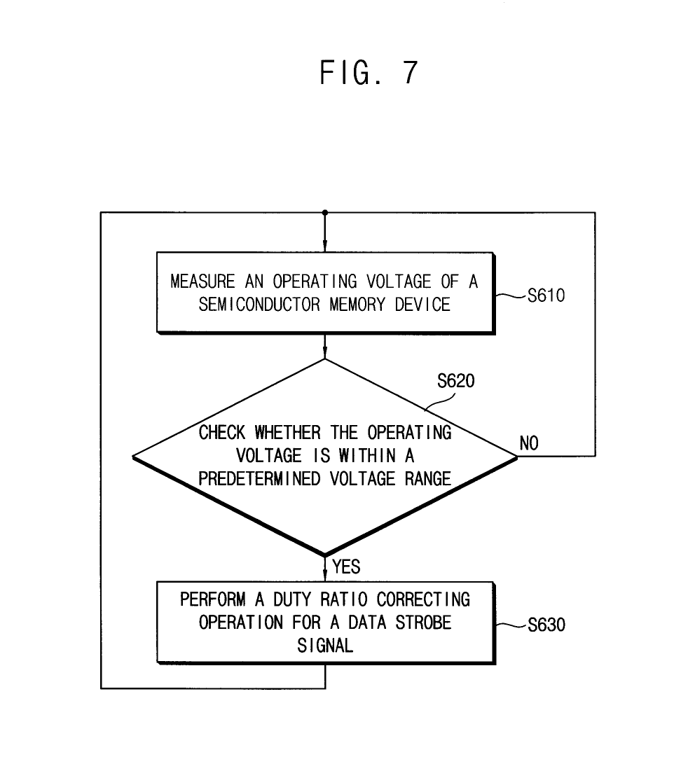

FIG. 7 is a flow chart illustrating an example in which the electronic device 100 performs the method of FIG. 1 based on an operating voltage of a semiconductor memory device.

Referring to FIG. 7, in Step S610 the electronic device 100 may measure the operating voltage of the semiconductor memory device 140. In Step S620, the electronic device 100 may use this measurement to determine if the operating voltage of the semiconductor memory device 140 is within a desired (or alternatively, a predetermined) voltage range. If the operating voltage of the semiconductor memory device 140 is within the desired or (or alternatively, the predetermined) voltage range, the duty ratio correcting operation may be performed for the data strobe signal DQS (Step S630). The DRC unit 130 may perform the duty ratio correcting operation for the data strobe signal DQS to adjust the duty ratio of the data strobe signal DQS by intentionally changing the duty ratio of the clock signal CK that is output from the system on-chip 120 to the semiconductor memory device 140. On the other hand, if the operating voltage of the semiconductor memory device 140 is not within the predetermined voltage range, the duty ratio correcting operation may not be performed for the data strobe signal DQS. Generally, a timing of the data strobe signal DQS may be influenced by an operating voltage change of the semiconductor memory device 140 while the electronic device 100 operates. Thus, the electronic device 100 may analyze an operation characteristics related to the operating voltage of the semiconductor memory device 140, and may perform the duty ratio correcting operation for the data strobe signal DQS if the operating voltage of the semiconductor memory device 140 is within the desired (or alternatively the predetermined) voltage range (i.e., a range in which a timing of the data strobe signal DQS is greatly changed). As a result, the electronic device 100 may operate relatively fast.

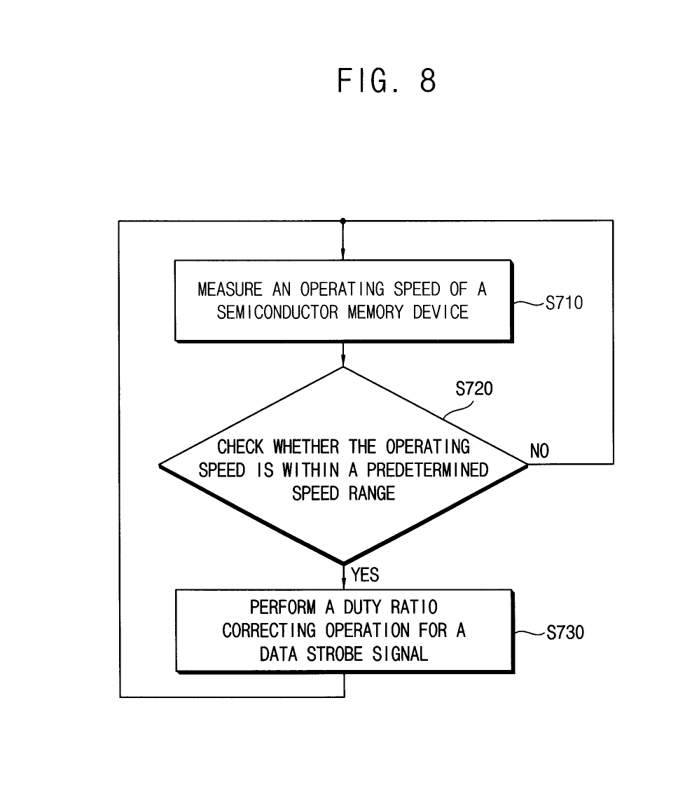

FIG. 8 is a flow chart illustrating an example embodiment in which the electronic device 100 performs the method of FIG. 1 based on an operating speed of a semiconductor memory device.

Referring to FIG. 8, in Step S710 the electronic device 100 may measure the operating speed of the semiconductor memory device 140 to check whether the operating speed of the semiconductor memory device 140 is within a desired (or alternatively a predetermined) speed range (Step S720). If the operating speed of the semiconductor memory device 140 is within the desired or (alternatively, the) predetermined speed range, the DRC unit 130 may perform the duty ratio correcting operation for the data strobe signal DQS (Step S730). The DRC unit 130 may perform the duty ratio correcting operation for the data strobe signal DQS to adjust the duty ratio of the data strobe signal DQS by intentionally changing the duty ratio of the clock signal CK that is output from the system on-chip 120 to the semiconductor memory device 140. On the other hand, if the operating speed of the semiconductor memory device 140 is not within the predetermined speed range, the DRC unit 130 may not perform the duty ratio correcting operation for the data strobe signal DQS. Generally, a timing of the data strobe signal DQS may be influenced by an operating speed change of the semiconductor memory device 140 while the electronic device 100 operates. Thus, the method of FIG. 1 may analyze an operation characteristics related to the operating speed of the semiconductor memory device 140, and may perform the duty ratio correcting operation for the data strobe signal DQS if the operating speed of the semiconductor memory device 140 is within the desired (or alternatively, the predetermined) speed range (i.e., a range in which a timing of the data strobe signal DQS is greatly changed). As a result, the electronic device 100 may operate relatively fast.

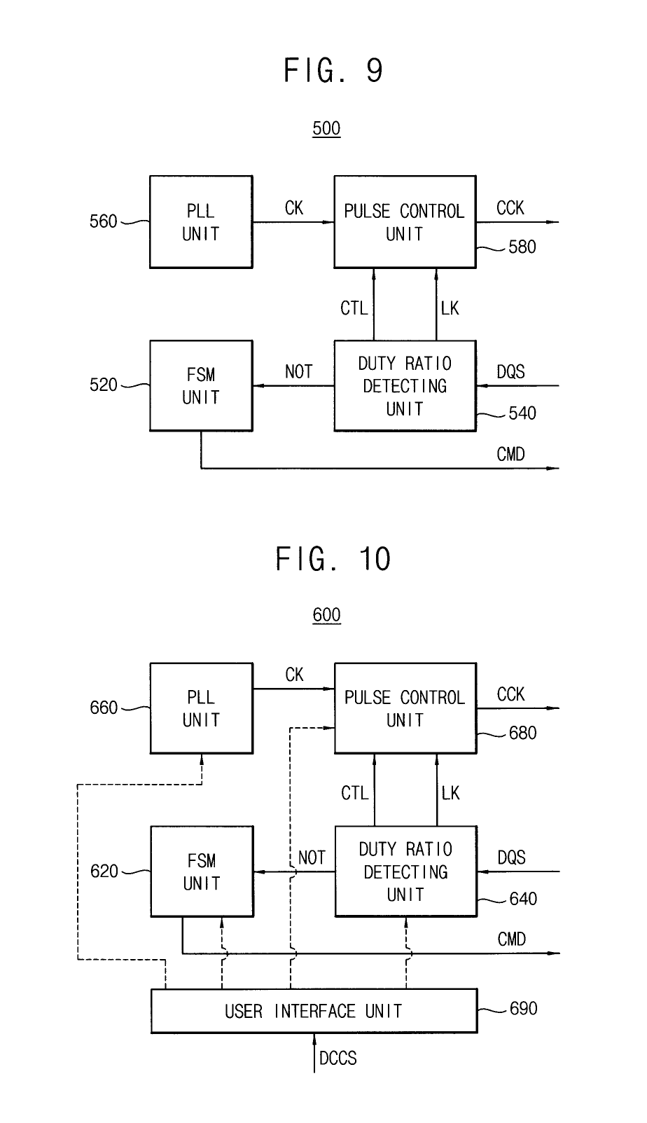

FIGS. 9-14 illustrate various example embodiments of the DRC unit 130 that may be embodied in the electronic device 100.

FIG. 9 is a block diagram illustrating a device configured to correct a duty ratio of a data strobe signal according to example embodiments.

Referring to FIG. 9, the device 500 may include a finite state machine (FSM) unit 520, a duty ratio detecting unit 540, a phase locked loop (PLL) unit 560, and a pulse control unit 580. The device 500 may be located between a system on-chip and a semiconductor memory device in an electronic device. In one example embodiment, the device 500 may be implemented (e.g., embedded) in the system on-chip. In another example embodiment, the device 500 may be implemented as a separate chip from the system on-chip. The semiconductor memory device to which the device 500 is coupled may be a DDR SDRAM device. However, a kind of the semiconductor memory device is not limited thereto. For example, the semiconductor memory device to which the device 500 is coupled may be any synchronous semiconductor memory device.

The device 500 may correct a duty ratio of a data strobe signal DQS (i.e., may reduce or eliminate a duty error of the data strobe signal DQS) by intentionally changing or adjusting (i.e., distorting) a duty ratio of a clock signal CK that is output from the system on-chip to the semiconductor memory device based on the duty ratio of the data strobe signal DQS that is output from the semiconductor memory device to the system on-chip. In detail, when the finite state machine unit 520 provides a read command signal CMD to the semiconductor memory device, the semiconductor memory device may output the data strobe signal DQS in response to the read command signal CMD. In one example embodiment, the finite state machine unit 520 may receive a result signal NOT from the duty ratio detecting unit 540, the result signal NOT indicating whether the duty ratio of the data strobe signal DQS becomes equal to a predetermined ratio (e.g., 50%), and may determine whether the finite state machine unit 520 provides the read command signal CMD to the semiconductor memory device based on the result signal NOT. For example, when the result signal NOT has a logic level (e.g., a logic high level or a logic low level) indicating that the duty ratio of the data strobe signal DQS is not equal to the desired (or alternatively the predetermined) ratio (e.g., 50%), the finite state machine unit 520 may provide the read command signal CMD to the semiconductor memory device.

The duty ratio detecting unit 540 may receive the data strobe signal DQS output from the semiconductor memory device, and may detect the duty ratio of the data strobe signal DQS. The data strobe signal DQS may include a first period corresponding to a logic high level period of the data strobe signal DQS and a second period corresponding to a logic low level period of the data strobe signal DQS. In one example embodiment, the duty ratio detecting unit 540 may define the duty ratio of the data strobe signal DQS as a ratio of the first period of the data strobe signal DQS to an entire period (i.e., a sum of the first period and the second period) of the data strobe signal DQS. The duty ratio detecting unit 540 may check whether the duty ratio of the data strobe signal DQS becomes equal to the desired (or alternatively, the predetermined) ratio. If the duty ratio of the data strobe signal DQS is not the desired (or alternatively the predetermined) ratio, the duty ratio detecting unit 540 may provide a control signal CTL to the pulse control unit 580 to perform a duty ratio correcting operation for the data strobe signal DQS. On the other hand, if the duty ratio of the data strobe signal DQS is the desired (or alternatively the predetermined) ratio, the duty ratio detecting unit 540 may provide a lock signal LK to the pulse control unit 580. For example, the duty ratio detecting unit 540 may provide the control signal CTL having a first logic level to the pulse control unit 580 when the duty ratio of the data strobe signal DQS is smaller than the desired (or alternatively the predetermined) ratio. On the other hand, the duty ratio detecting unit 540 may provide the control signal CTL having a second logic level to the pulse control unit 580 when the duty ratio of the data strobe signal DQS is greater than the desired (or alternatively the predetermined) ratio.

By providing the result signal NOT to the finite state machine unit 520, the result signal NOT indicating whether the duty ratio of the data strobe signal DQS becomes equal to the desired (or alternatively the predetermined) ratio, the duty ratio detecting unit 540 may repeatedly perform the duty ratio correcting operation for the data strobe signal DQS until the duty ratio of the data strobe signal DQS becomes equal to the desired (or alternatively the predetermined) ratio.

In some example embodiments, the duty ratio detecting unit 540 may be implemented by various circuits. For example, the duty ratio detecting unit 540 may include a delay chain unit having a plurality of delay chains that provide a delay corresponding to one cycle of a specific clock signal. The duty ratio detecting unit 540 may detect which of the first period, corresponding to the logic high level period of the data strobe signal DQS, and the second period, corresponding to the logic low level period of the data strobe signal DQS, is longer by checking logic levels of output signals of the delay chains. The logic levels of the output signals of the delay chains indicating logic levels of the data strobe signal DQS. However, a structure of the duty ratio detecting unit 540 is not limited thereto.

The phase locked loop unit 560 may generate the clock signal CK to provide the clock signal CK to the pulse control unit 580. Here, in the device 500, the clock signal CK generated by the phase locked loop unit 560 may be output via the pulse control unit 580 (i.e., as a corrected clock signal CCK). For convenience of descriptions, the clock signal CK indicates a signal output from the phase locked loop unit 560, and the corrected clock signal CCK indicates a signal output from the pulse control unit 580. That is, the pulse control unit 580 may receive the clock signal CK from the phase locked loop unit 560, and may change the duty ratio of the clock signal CK based on the control signal CTL output from the duty ratio detecting unit 540. For example, if the duty ratio detecting unit 540 provides the control signal CTL having the first logic level when the duty ratio of the data strobe signal DQS is smaller than the desired (or alternatively the predetermined) ratio, the pulse control unit 580 may increase the duty ratio of the clock signal CK. On the other hand, if the duty ratio detecting unit 540 provides the control signal CTL having the second logic level when the duty ratio of the data strobe signal DQS is greater than the desired (or alternatively the predetermined) ratio, the pulse control unit 580 may reduce the duty ratio of the clock signal CK.

The pulse control unit 580 may not change the duty ratio of the clock signal CK output from the phase locked loop unit 560 if the duty ratio detecting unit 540 outputs the lock signal LK. That is, when the lock signal LK is output form the duty ratio detecting unit 540, the pulse control unit 580 may not change the duty ratio of the clock signal CK because the duty ratio of the data strobe signal DQS is equal to the desired (or alternatively, the predetermined) ratio.

The clock signal CK may include a third period corresponding to a logic high level period of the clock signal CK and a fourth period corresponding to a logic low level period of the clock signal CK. The duty ratio of the clock signal CK may be defined as a ratio of the third period of the clock signal CK to an entire period (i.e., a sum of the third period and the fourth period) of the clock signal CK. The pulse control unit 580 may increase the duty ratio of the clock signal CK by lengthening the third period and/or by shortening the fourth period, if the duty ratio of the data strobe signal DQS is smaller than the desired (or alternatively, the predetermined) ratio. On the other hand, the pulse control unit 580 may reduce the duty ratio of the clock signal CK by shortening the third period corresponding to the logic high level period of the clock signal CK and/or by lengthening the fourth period corresponding to the logic low level period of the clock signal CK, if the duty ratio of the data strobe signal DQS is greater than the desired (or alternatively, the predetermined) ratio. In some example embodiments, the pulse control unit 580 may be implemented by various circuits. For example, the pulse control unit 580 may include a delay unit that generates a delayed clock signal. The pulse control unit 580 may generate the corrected clock signal CCK by performing AND-operations or OR-operations between the clock signal CK and the delayed clock signal. However, a structure of the pulse control unit 580 is not limited thereto.

As described above, using the feature that the duty ratio of the data strobe signal DQS depends on the duty ratio of the clock signal CK, the device 500 may maintain the duty ratio of the data strobe signal DQS to a desired value (e.g., 50%) by intentionally changing or adjusting the duty ratio of the clock signal CK that is output from the system on-chip to the semiconductor memory device based on the duty ratio of the data strobe signal DQS that is output from the semiconductor memory device to the system on-chip. Thus, compared to conventional duty ratio correction techniques that focus on maintaining the duty ratio of the clock signal CK to be a desired value (e.g., 50%), the device 500 may reduce a duty error of the data strobe signal DQS that is output from the semiconductor memory device to the system on-chip. As a result, an effective time of data may be greatly increased for the electronic device. Hence, the electronic device may operate relatively fast while achieving high operation reliability. In addition, the device 500 may continuously or selectively operate according to required conditions for the electronic device.

FIG. 10 is a block diagram illustrating an example in which a device of FIG. 9 includes a user interface for receiving a duty ratio correction command signal.

Referring to FIG. 10, the device 600 may include a finite state machine unit 620, a duty ratio detecting unit 640, a phase locked loop unit 660, a pulse control unit 680, and a user interface unit 690. Here, the device 600 may be located between a system on-chip and a semiconductor memory device in an electronic device. In one example embodiment, the device 600 may be implemented (e.g., embedded) in the system on-chip. In another example embodiment, the device 600 may be implemented as a separate chip from the system on-chip. Since the finite state machine unit 620, the duty ratio detecting unit 640, the phase locked loop unit 660, and the pulse control unit 680 are described above, duplicated descriptions will be omitted.

As illustrated in FIG. 10, the device 600 may include the user interface unit 690 for receiving a duty ratio correction command signal DCCS. Thus, the device 600 may not continuously perform a duty ratio correcting operation for the data strobe signal DQS, but may perform the duty ratio correcting operation for the data strobe signal DQS if the duty ratio correction command signal DCCS is input to the device 600 (e.g., by a user). For example, the user interface unit 690 may operate the finite state machine unit 620, the duty ratio detecting unit 640, the phase locked loop unit 660, and the pulse control unit 680 if the duty ratio correction command signal DCCS is received. As a result, the electronic device may operate relatively fast.

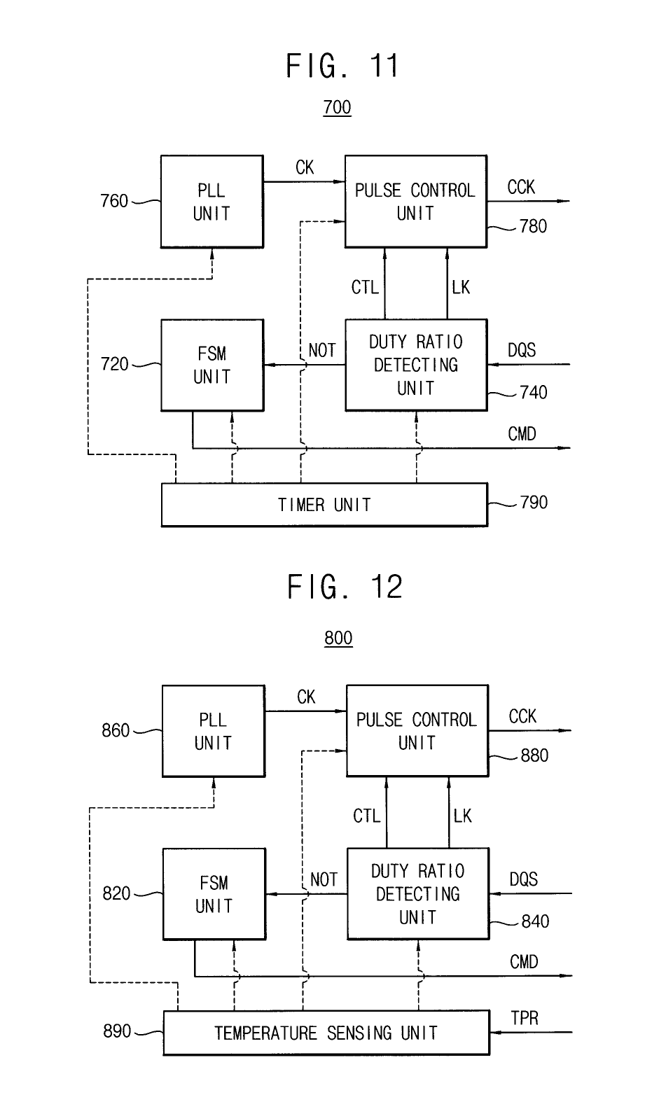

FIG. 11 is a block diagram illustrating an example in which a device of FIG. 9 includes a timer unit for providing the desired (or alternatively, the predetermined) cycle.

Referring to FIG. 11, the device 700 may include a finite state machine unit 720, a duty ratio detecting unit 740, a phase locked loop unit 760, a pulse control unit 780, and a timer unit 790. The device 700 may be located between a system on-chip and a semiconductor memory device in an electronic device. In one example embodiment, the device 700 may be implemented (e.g., embedded) in the system on-chip. In another example embodiment, the device 700 may be implemented as a separate chip from the system on-chip. Since the finite state machine unit 720, the duty ratio detecting unit 740, the phase locked loop unit 760, and the pulse control unit 780 are described above, the duplicated descriptions will be omitted.

As illustrated in FIG. 11, the device 700 may include the timer unit 790 for measuring (e.g., counting) a desired (or alternatively, a predetermined) time. Thus, the device 700 may perform a duty ratio correcting operation for the data strobe signal DQS based on the desired (or alternatively, the predetermined) cycle (i.e., every desired or predetermined cycle). For example, the timer unit 790 may operate the finite state machine unit 720, the duty ratio detecting unit 740, the phase locked loop unit 760, and the pulse control unit 780 every desired (or alternatively, predetermined) cycle. As a result, the electronic device may operate relatively fast.

FIG. 12 is a block diagram illustrating an example in which a device of FIG. 9 includes a temperature sensing unit for sensing a temperature of a semiconductor memory device.

Referring to FIG. 12, the device 800 may include a finite state machine unit 820, a duty ratio detecting unit 840, a phase locked loop unit 860, a pulse control unit 880, and a temperature sensing unit 890. Here, the device 800 may be located between a system on-chip and a semiconductor memory device in an electronic device. In one example embodiment, the device 800 may be implemented (e.g., embedded) in the system on-chip. In another example embodiment, the device 800 may be implemented as a separate chip from the system on-chip. Since the finite state machine unit 820, the duty ratio detecting unit 840, the phase locked loop unit 860, and the pulse control unit 880 are described above, the duplicated descriptions will be omitted.

As illustrated in FIG. 12, the device 800 may include the temperature sensing unit 890 for sensing a temperature TPR of the semiconductor memory device. Thus, the device 800 may perform a duty ratio correcting operation for the data strobe signal DQS if the temperature TPR of the semiconductor memory device is within a desired (or alternatively, a predetermined) temperature range. That is, the device 800 may not perform the duty ratio correcting operation for the data strobe signal DQS if the temperature TPR of the semiconductor memory device is not within the desired (or alternatively, the predetermined) temperature range. For example, the temperature sensing unit 890 may operate the finite state machine unit 820, the duty ratio detecting unit 840, the phase locked loop unit 860, and the pulse control unit 880 if the temperature TPR of the semiconductor memory device is within the desired (or alternatively, the predetermined) temperature range. As a result, the electronic device may operate relatively fast.

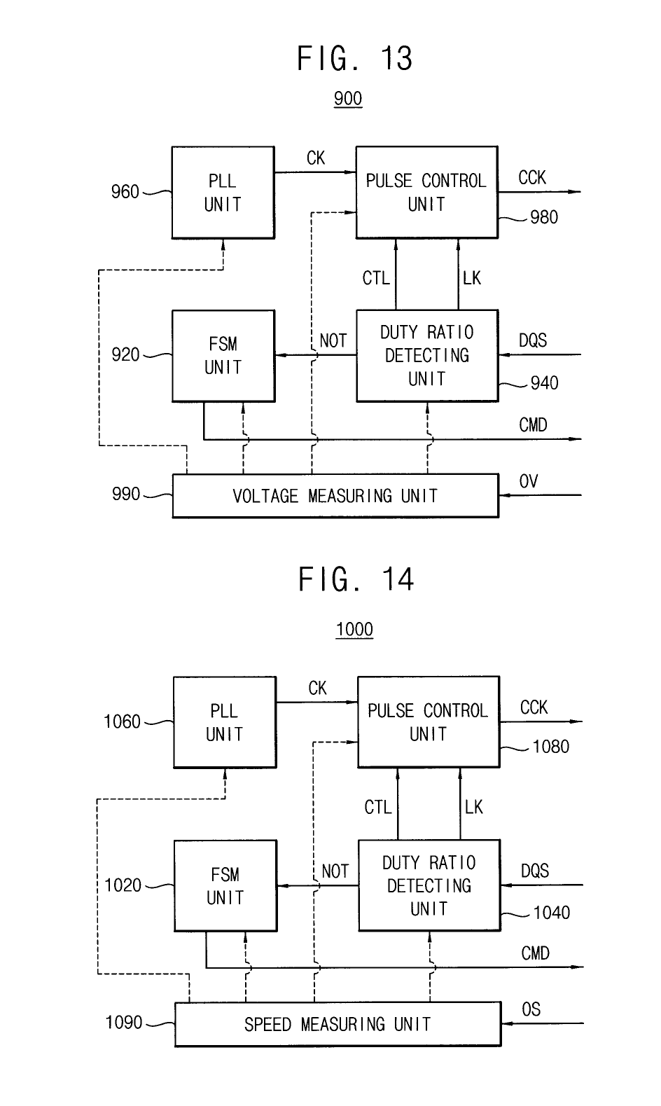

FIG. 13 is a block diagram illustrating an example in which a device of FIG. 9 includes a voltage measuring unit for measuring an operating voltage of a semiconductor memory device.

Referring to FIG. 13, the device 900 may include a finite state machine unit 920, a duty ratio detecting unit 940, a phase locked loop unit 960, a pulse control unit 980, and a voltage measuring unit 990. The device 900 may be located between a system on-chip and a semiconductor memory device in an electronic device. In one example embodiment, the device 900 may be implemented (e.g., embedded) in the system on-chip. In another example embodiment, the device 900 may be implemented as a separate chip from the system on-chip. Since the finite state machine unit 920, the duty ratio detecting unit 940, the phase locked loop unit 960, and the pulse control unit 980 are described above, the duplicated descriptions will be omitted. As illustrated in FIG. 13, the device 900 may include the voltage measuring unit 990 for measuring an operating voltage OV of the semiconductor memory device. Thus, the device 900 may perform a duty ratio correcting operation for the data strobe signal DQS if the operating voltage OV of the semiconductor memory device is within a desired (or alternatively, a predetermined) voltage range. That is, the device 900 may not perform the duty ratio correcting operation for the data strobe signal DQS if the operating voltage OV of the semiconductor memory device is not within the desired (or alternatively, the predetermined) voltage range. For example, the voltage measuring unit 990 may operate the finite state machine unit 920, the duty ratio detecting unit 940, the phase locked loop unit 960, and the pulse control unit 980 if the operating voltage OV of the semiconductor memory device is within the desired (or alternatively, the predetermined) voltage range. As a result, the electronic device may operate relatively fast.

FIG. 14 is a block diagram illustrating an example in which a device of FIG. 9 includes a speed measuring unit for measuring an operating speed of a semiconductor memory device.

Referring to FIG. 14, the device 1000 may include a finite state machine unit 1020, a duty ratio detecting unit 1040, a phase locked loop unit 1060, a pulse control unit 1080, and a speed measuring unit 1090. The device 1000 may be located between a system on-chip and a semiconductor memory device in an electronic device. In one example embodiment, the device 1000 may be implemented (e.g., embedded) in the system on-chip. In another example embodiment, the device 1000 may be implemented as a separate chip from the system on-chip. Since the finite state machine unit 1020, the duty ratio detecting unit 1040, the phase locked loop unit 1060, and the pulse control unit 1080 are described above, the duplicated descriptions will be omitted. As illustrated in FIG. 14, the device 1000 may include the speed measuring unit 1090 for measuring an operating speed OS of the semiconductor memory device. Thus, the device 1000 may perform a duty ratio correcting operation for the data strobe signal DQS only when the operating speed OS of the semiconductor memory device is within a desired (or alternatively, a predetermined) speed range. That is, the device 1000 may not perform the duty ratio correcting operation for the data strobe signal DQS if the operating speed OS of the semiconductor memory device is not within the desired (or alternatively, the predetermined) speed range. For example, the speed measuring unit 1090 may operate the finite state machine unit 1020, the duty ratio detecting unit 1040, the phase locked loop unit 1060, and the pulse control unit 1080 if the operating speed OS of the semiconductor memory device is within the desired (or alternatively, the predetermined) speed range. As a result, the electronic device may operate relatively fast.

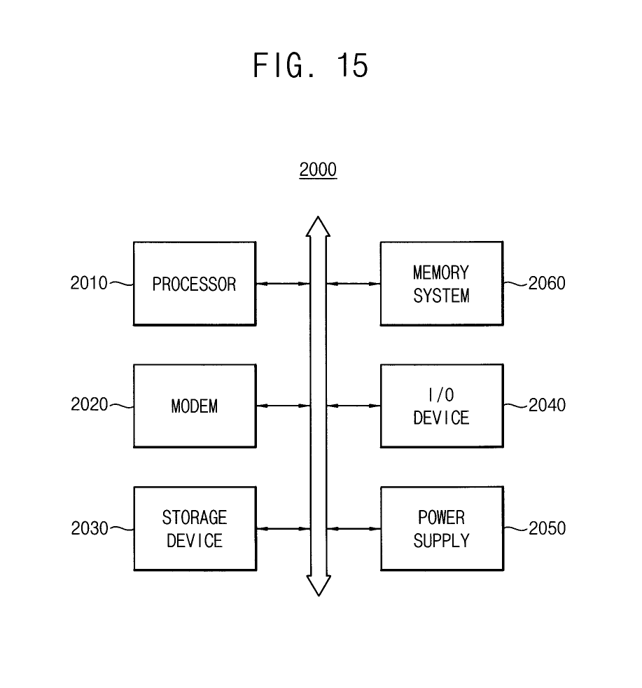

FIG. 15 is a block diagram illustrating a mobile system that includes a device for correcting a duty ratio of a data strobe signal according to some embodiments.

Referring to FIG. 15, the mobile system 2000 may include a processor 2010, a modern 2020, a storage device 2030, an input/output (I/O) device 2040, a power supply 2050, and a memory system 2060. In addition, the mobile system 2000 may further include a camera image processor (CIS) (not shown), etc.

The processor 2010 may perform various computing functions. For example, the processor 2010 may execute applications such as an internet browser application, a 3D-map application, etc. The processor 2010 may be coupled to other components via an address bus, a control bus, a data bus, etc. In some example embodiments, the processor 2010 may be an application processor (AP), a micro processor, a central processing unit (CPU), etc. The modem 2020 may receive external data from outside the mobile system 2000 and may transmit internal data to outside the mobile system 2000. For example, the modem 2020 may be a modem processor that supports a global system for mobile communication (GSM), a general packet radio service (GPRS), a wideband code division multiple access (WCDMA), a high speed packet access (HS×PA), etc. In some example embodiments, the processor 2010 and the modem 2020 may be implemented in one chip. The storage device 2030 may include a solid state drive (SSD) device, a hard-disk drive (HDD) device, a CD-ROM device, etc. The I/O device 2040 may include an input device such as a keyboard, a keypad, a mouse, a touch screen, etc, and an output device such as a printer, a display device, a speaker, etc. The power supply 2050 may provide power for operating the mobile system 2000.

The memory system 2060 may store data used to operate the mobile system 2000. The memory system 2060 may include a plurality of semiconductor memory devices and a memory controller for controlling the semiconductor memory devices. The semiconductor memory devices may include non-volatile memory devices and/or volatile memory devices. At least one of the semiconductor memory devices may be a synchronous semiconductor memory device that operates based on a data strobe signal. Thus, a device for correcting a duty ratio of the data strobe signal according to some embodiments may be located in the memory system 2060 between the memory controller and the synchronous semiconductor memory device. The device may include a finite state machine unit, a duty ratio detecting unit, a phase locked loop unit, and a pulse control unit. In example embodiments, the device may further include a user interface unit, a timer unit, a temperature sensing unit, a voltage measuring unit, or a speed measuring unit. Since the device is described above, the duplicated descriptions will be omitted.

The non-volatile memory devices of the memory system 2060 may store booting codes for boot-operations of the mobile system 2000. For example, the non-volatile memory devices may include an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. The volatile memory devices of the memory system 2060 may store data transferred (i.e., received or transmitted) by the modem 2020 and/or data processed by the processor 2010. For example, the volatile memory devices may include a DDR SDRAM device, a dynamic random access memory (DRAM) device, a static random access memory (SRAM) device, a mobile DRAM device, etc. In some example embodiments, the mobile system 2000 may be implemented using various kinds of packages. For example, the packages may include package on package (PoP), a ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat-pack (TQFP), small outline integrated circuit (SOIC), shrink small outline package (SSOP), thin small outline package (TSOP), thin quad flat-pack (TQFP), system in package (SIP), multi chip package (MCP), wafer-level fabricated package (WFP), wafer-level processed stack package (WSP), etc.

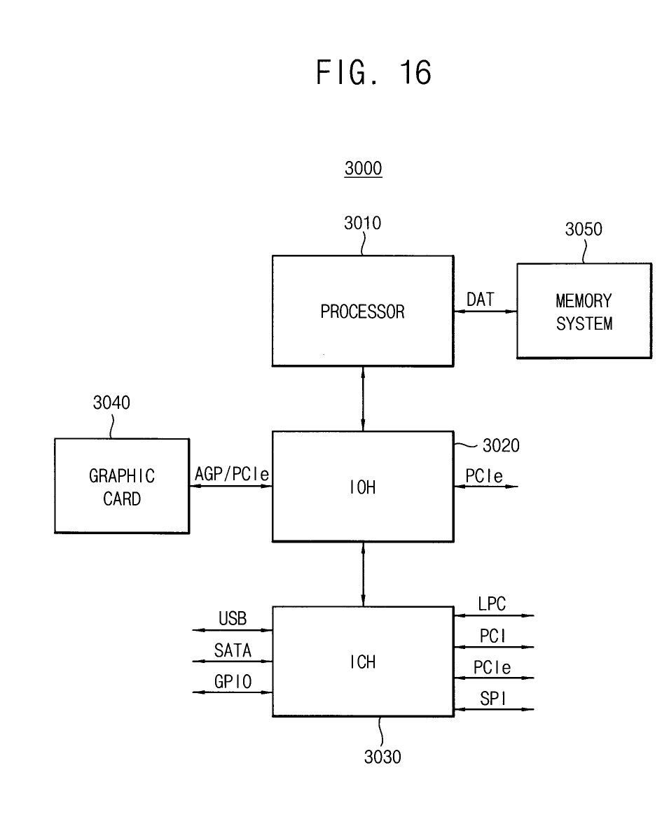

FIG. 16 is a block diagram illustrating a computing system that includes a device for correcting a duty ratio of a data strobe signal according to some embodiments.

Referring to FIG. 16, the computing system 3000 includes a processor 3010, an input/output hub (IOH) 3020, an I/O controller hub (ICH) 3030, a graphics card 3040, and a memory system 3050.

The processor 3010 performs various computing functions. For example, the processor 3010 may be a microprocessor, a central process unit (CPU), etc. In some example embodiments, the processor 3010 may include a single core or multiple cores such as a dual-core processor, a quad-core processor, a hexa-core processor, etc. The processor 3010 may further include an internal or external cache memory. The I/O hub 3020 may manage data transfer operations between the processor 3010 and devices such as the graphics card 3040. The I/O hub 3020 may be coupled to the processor 3010 based on various interfaces. For example, the interface between the processor 3010 and the I/O hub 3020 may be a front side bus (FSB), a system bus, a HyperTransport, a lightning data transport (LDT), a QuickPath interconnect (QPI), a common system interface (CSI), etc. Further, the I/O hub 3020 may provide various interfaces with the devices. For example, the I/O hub 3020 may provide an accelerated graphics port (AGP) interface, a peripheral component interface-express (PCIe), a communications streaming architecture (CSA) interface, etc.

The graphics card 3040 may be coupled to the I/O hub 3020 via AGP or PCIe for controlling a display device (not shown) to display an image. The graphics card 3040 may include an internal processor for processing image data. In some example embodiments, the I/O hub 3020 may include an internal graphics device instead of the graphics card 3040. Here, the graphics device included in the I/O hub 3020 may be referred to as integrated graphics. Further, the I/O hub 3030 including the internal memory controller and the internal graphics device may be referred to as a graphics and memory controller hub (GMCH). The I/O controller hub 3030 may perform data buffering and interface arbitration operations to efficiently operate various system interfaces. The I/O controller hub 3030 may be coupled to the I/O hub 3020 via an internal bus, such as a direct media interface (DMI), a hub interface, an enterprise Southbridge interface (ESI), PCIe, etc. The I/O controller hub 3030 may interface with peripheral devices. For example, the I/O controller hub 3030 may provide a universal serial bus (USB) port, a serial advanced technology attachment (SATA) port, a general purpose input/output (GPIO), a low pin count (LPC) bus, a serial peripheral interface (SPI), PCI, PCIe, etc.

The memory system 3050 may store data for operating the computing system 3000. The memory system 3050 may include a plurality of semiconductor memory devices and a memory controller for controlling the semiconductor memory devices. The semiconductor memory devices may include non-volatile memory devices and/or volatile memory devices. At least one of the semiconductor memory devices may be a synchronous semiconductor memory device that operates based on a data strobe signal. Thus, a device for correcting a duty ratio of the data strobe signal according to some embodiments may be located in the memory system 3050 between the memory controller and the synchronous semiconductor memory device. The device may include a finite state machine unit, a duty ratio detecting unit, a phase locked loop unit, and a pulse control unit. In example embodiments, the device may further include a user interface unit, a timer unit, a temperature sensing unit, a voltage measuring unit, or a speed measuring unit. Since the device is described above, the duplicated descriptions will be omitted. In some example embodiments, the computing system 3000 may be a personal computer, a server computer, a workstation, a laptop, etc.

The present inventive concepts may be applied to a semiconductor memory device (e.g., a DDR SDRAM device) that operates based on a data strobe signal, and an electronic device having the semiconductor memory device. For example, the present inventive concepts may be applied to an electronic device such as a computer, a laptop, a cellular phone, a smart phone, a smart pad, a personal digital assistant (PDA), a portable multimedia player (PMP), a digital camera, a digital television, a MP3 player, a portable game console, etc. The foregoing is illustrative of example embodiments and is not to be construed as limiting thereof. Although example embodiments have been described, those skilled in the art will readily appreciate that many modifications are possible in the example embodiments without materially departing from the novel teachings and advantages of the present inventive concepts. Accordingly, all such modifications are intended to be included within the scope of the present inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of correcting a duty ratio of a data strobe signal, the method comprising:
detecting a duty ratio of a data strobe signal output from a semiconductor memory device; and
adjusting a duty ratio of a clock signal input to the semiconductor memory device based on the duty ratio of the data strobe signal.

2. The method of claim 1, wherein the semiconductor memory device is a double data rate synchronous dynamic random access memory (DDR SDRAM) device.

3. The method of claim 1, wherein the adjusting is repeatedly performed until the duty ratio of the data strobe signal is a desired ratio.

4. The method of claim 3, wherein the desired ratio is 50%.

5. The method of claim 3, wherein the repeatedly performing the adjusting ends, if the duty ratio of the data strobe signal is equal to the desired ratio.

6. The method of claim 5, wherein the data strobe signal includes a first period and a second period, the first period corresponding to a period where the data strobe signal has a logic high level and the second period corresponding to a period where the data strobe signal has a logic low level, and
wherein the duty ratio of the data strobe signal corresponds to a ratio of the first period to a sum of the first period and the second period.

7. The method of claim 6, wherein the clock signal includes a third period and a fourth period, the third period corresponding to a period where the clock signal has a logic high level and the fourth period corresponding to a period where the clock signal has a logic low level period of the clock signal, and
wherein the duty ratio of the clock signal corresponds to a ratio of the third period to a sum of the third period and the fourth period.

8. The method of claim 7, wherein the adjusting comprises:
increasing the duty ratio of the clock signal, if the duty ratio of the data strobe signal is less than the desired ratio; and
reducing the duty ratio of the clock signal, if the duty ratio of the data strobe signal is greater than the desired ratio.

9. The method of claim 8, wherein increasing the duty ratio of the clock signal includes at least one of lengthening the third period and shortening the fourth period, if the duty ratio of the data strobe signal is less than the desired ratio.

10. The method of claim 8, wherein reducing the duty ratio of the clock signal includes at least one of shortening the third period and lengthening the fourth period, if the duty ratio of the data strobe signal is greater than the desired ratio.

11. The method of claim 3, wherein the detecting and the adjusting are performed only if a duty ratio correction command signal is received.

12. The method of claim 3, wherein the detecting and the adjusting is performed based on a desired cycle.

13. The method of claim 3, wherein the detecting and the adjusting are performed, if a temperature of the semiconductor memory device is within a desired temperature range.

14. The method of claim 3, wherein the detecting and the adjusting are performed only if an operating voltage of the semiconductor memory device is within a desired voltage range.

15. The method of claim 3, wherein the detecting and the adjusting are performed only if an operating speed of the semiconductor memory device is within a desired speed range.

16. A method of controlling a duty ratio of an output signal output from a semiconductor memory device, the duty ratio of the output signal depending on a duty ratio of a clock signal input to the semiconductor memory device, the method comprising:
adjusting a duty ratio of the clock signal input to the semiconductor memory device, if the duty ratio of the output signal from the semiconductor memory device deviates from a desired ratio.

17. The method of claim 16, wherein the adjusting comprises:
increasing the duty ratio of the clock signal, if the duty ratio of the output signal is less than the desired ratio; and
reducing the duty ratio of the clock signal, if the duty ratio of the output signal is greater than the desired ratio.

18. The method of claim 17, wherein the increasing includes at least one of lengthening the on period of the clock signal and shortening the off period of the clock signal, if the duty ratio of the output signal is smaller than the desired ratio.

19. The method of claim 17, wherein reducing includes at least one of shortening an on period of the clock signal and lengthening an off period of the clock signal, if the duty ratio of the output signal is greater than the desired ratio.

20. The method of claim 16, wherein the adjusting is performed a number of times, the number of times based on one of an operating voltage of the semiconductor memory device and an operating speed of the semiconductor memory device.
